(19) United States
(12) Patent Application Publication
(10) Pub. No.: US 2004/0079734 A1
(43) Pub. Date: Apr. 29, 2004

(54) Low back reflection fiber optic cable termination and method of making same

(76) Inventor: James M. Sanderson, Moore, SC (US)

Correspondence Address: ECKERT SEAMANS CHERIN & MOLLETT, LLC, ALCOA TECHNICAL CENTER, 100 TECHNICAL DRIVE, ALCOA CENTER, PA, 15069-0001, US

(21) Appl. No.: 10/280,470

(22) Filed: Oct. 25, 2002

(51) Int. Cl. B23K 9/00

(52) U.S. Cl. 219/121.46

(57) ABSTRACT

A method of making a fiber optic cable termination comprises the steps of clamping an optical fiber between two spaced-apart clamps, heating the optical fiber, moving at least one of the clamps toward the other clamp to bend a first portion of the optical fiber into an S-shaped bend, wherein the S-shaped bend includes two or more bends, each having a radius of curvature of less than the diameter of the optical fiber. The step of heating the optical fiber can include the step of applying heat to the optical fiber before, during and after the step of moving at least one of the clamps toward the other clamp to bend the optical fiber or the clamps can be separated to form a tapered end on the optical fiber. A fiber optic cable termination comprising an optical fiber formed into a S-shaped bend, and/or a tapered portion is also disclosed.

### FIELD OF THE INVENTION

This invention relates to fiber optic cable, and more particularly, to fiber optic cable terminations and methods of making such terminations.

### BACKGROUND OF THE INVENTION

Fiber optic cable is widely used in communications systems. Portions of light passing through cable splices or into cable terminations can be reflected back toward the light source. This back reflected light can interfere with transmitters, amplifiers, multiplexers, and other system components causing data errors to increase. Back reflected light is also a problem for test and measurement instruments such as optical time domain reflectometers and back reflection meters as well as interferometric based sensors.

One problem that occurs in fiber optic networks having extra capacity is back reflected light from unterminated ends. Such applications require low back reflection terminations.

Current techniques to generate low back reflection terminations include: polishing the end of a fiber at a precise angle; placing the end of the fiber in an index matching gel or oil; or attaching a component to the end of the fiber.

The first technique requires a polisher and several minutes to complete. A connector may be required on the end of a fiber. For many applications, a connector is too large for the allotted space. The second technique requires coupling the fiber to a small container filled with oil or gel. The container may leak allowing the oil or gel to spill. Connecting the fiber to a container may require several minutes of waiting for an adhesive to cure. The third technique requires a small component attached to the end of the fiber. That technique also requires several minutes to attach the component to the fiber. All of the above techniques require specialized tools and/or supplies and require several minutes to install.

There is a need for a fiber optic cable terminal that can achieve low back reflection and can be quickly and easily formed near the end of an optical fiber.

### SUMMARY OF THE INVENTION

This invention provides a method of making a fiber optic cable termination comprising the steps of clamping an optical fiber between two spaced-apart clamps, heating the optical fiber, moving at least one of the clamps toward the other clamp to bend a first portion of the optical fiber into an S-shaped bend, wherein the S-shaped bend includes two or more bends, each having a radius of curvature of less than the diameter of the optical fiber.

The step of heating the optical fiber can include the step of applying an arc to the optical fiber before, during and after the step of moving at least one of the clamps toward the other clamp to bend the optical fiber. The S-shaped bend can have a tensile strength of at least 20 kpsi.

In another aspect of the invention, heat can be applied to a portion of the optical fiber and the clamps can be separated to form a tapered end on the optical fiber. The tapered portion can be tapered at an angle of greater than 0.1° with respect to a side of the optical fiber. The tapered portion can be positioned adjacent to an end of the optical fiber to form a termination that exhibits low back reflection.

Terminations can be made in accordance with the above methods for both single mode fibers and multimode fibers.

The invention also encompasses optical fiber terminations including an S-shaped bend, wherein the S-shaped bend includes two or more bends, each having a radius of curvature of less than the diameter of the optical fiber.

Another aspect of the invention encompasses optical fiber terminations including a tapered portion adjacent to an end of the optical fiber, with the tapered portion being tapered at an angle of greater than 0.1° with respect to a side of the optical fiber.

The invention further encompasses a fiber optic cable termination comprising an optical fiber formed into a S-shaped bend, and a tapered portion between the S-shaped bend and an end of the optical fiber. The S-shaped bend includes two or more bends that bend in opposite directions. Both the S-shaped bend and the tapered portion can contribute to the non-reflective properties of the termination.

### BRIEF DESCRIPTION OF THE DRAWINGS

FIG. 1 is a schematic representation of a portion of an apparatus used to terminate an optical fiber in accordance with the invention.

FIG. 2 is a schematic representation of the apparatus of FIG. 1 illustrating an intermediate step in the method.

FIG. 3 is a schematic representation of the apparatus of FIG. 1 illustrating another intermediate step in the method.

FIG. 4 is a side view of an optical fiber termination made in accordance with the invention.

FIG. 5 is a block diagram of an apparatus that was used to demonstrate the invention.

### DETAILED DESCRIPTION OF PREFERRED EMBODIMENTS

This invention provides low back reflection fiber optic cable terminations and a method for making the terminations by heating a portion of an optical fiber and compressing the fiber in an axial direction to form a bend in the fiber. The method can be accomplished by using an arc fusion splicer to heat a small portion of the optical fiber and then applying a compressive force to the fiber in an axial direction causing one or more tight “S” shaped bends in the fiber. The section of the fiber beyond the bend can then be cut or further processed separately to produce a tapered portion adjacent to an end thereof.

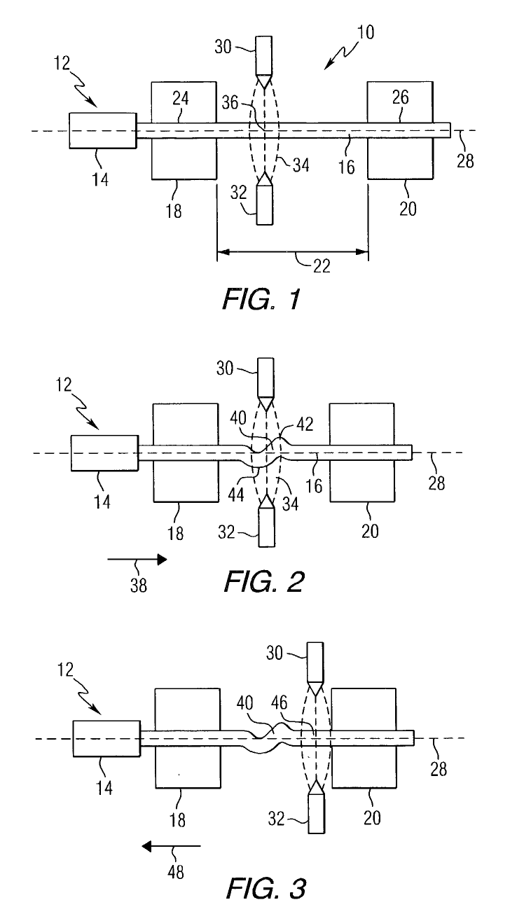

Referring to the drawings, FIG. 1 is a schematic representation of a portion of an apparatus 10 used to terminate an optical fiber cable 12 in accordance with the invention. The outer jacket 14 of the cable has been removed to expose the optical fiber 16. The apparatus includes means for holding a section of the optical fiber 16, in the form of first and second clamps 18 and 20 separated by a distance 22. The clamps are initially positioned such that the clamped portions 24 and 26 of the optical fiber are aligned along an axis 28. Electrodes 30 and 32 are positioned on opposite sides of the optical fiber to apply an arc 34 to heat a section 36 of the optical fiber. In one embodiment of the invention, the distance between the clamps can be about 1 cm for processing an optical fiber having a diameter of, for example, 80 μm, 125 μm, 140 μm, 250 μm, etc. The arc heats a portion of the fiber, such that the length of the heated portion is approximately on the order of 10× the diameter of the fiber. In one example, the arc field can be approximately 3 mm in width.

FIG. 2 is a schematic representation of the apparatus of FIG. 1 illustrating an intermediate step in the method. After the arc has softened the optical fiber, clamp 18 is moved in a direction indicated by arrow 38 to axially compress the optical fiber and cause the fiber to deform, thereby creating a tight S-shaped bent section 40 in the optical fiber. In the method of this invention, the glass is softened and bent, without actually being melted. Fused silica glass (optical fiber) is amorphous and has a continuous viscosity that exponentially decreases as the temperature is increased. It softens at approximately 1600-1700° C. and flows at approximately 1900-2000° C. depending on the specific type. The arc power used to create the S-bend is the same as that used to normally splice two separate fibers together, however the arc time used to create the S-bend is significantly less than the normal arc time used to fuse two separate fibers together. The energy (heat) transferred to the splice region of the S-bend fiber is less than that transferred for normal fiber splicing. Thus, the temperature of the S-bend fiber is less than that normally used to fuse two fibers together. The method of this invention intentionally introduces an axial offset in the vicinity of the heated portion of the fiber by slightly softening the fiber and pushing it together versus completely softening the fiber before pushing it together.

The S-shaped bend portion includes two closely spaced bends 42 and 44 that bend in opposite directions. The bends each have a radius less than a maximum bend radius that will produce the desired attenuation in the optical fiber. For example, the S-shaped bend can include two bends each having a radius of curvature of less than the diameter of the fiber. These two bends together provide a return loss of at least 50 dB.

In another aspect of the invention, the arc can be applied to a section 46 of the fiber, and clamp 18 can be moved in the direction indicated by arrow 48. This would cause the optical fiber to stretch, thereby reducing the cross-sectional area in the vicinity of the heated section. Eventually the fiber will break, leaving a tapered portion adjacent to the end. The second section can be, for example, 1 to 1.5 mm from an end of the S-shaped section. Alternatively, a termination can be formed using the tapered section without the S-shaped bend. The taper provides a return loss of at least 20 dB.

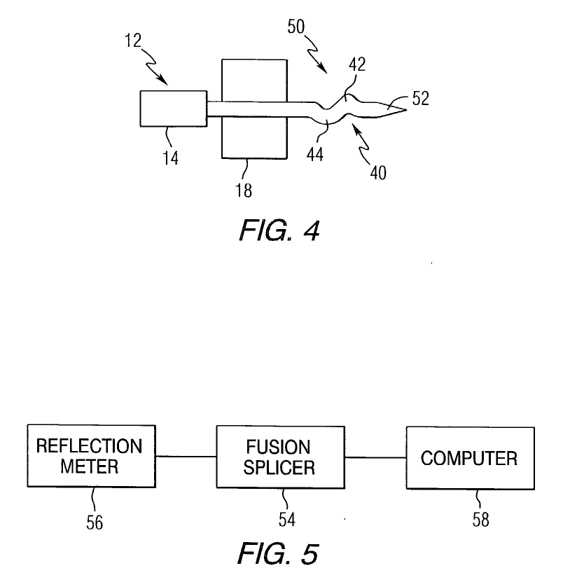

FIG. 4 is a side view of an optical fiber termination 50 made in accordance with the invention. The termination includes a tight S-shaped bent section 40 including two bends 42 and 44, and a tapered section 52 in the optical fiber. The angle of the tapered portion of the termination should be, for example, greater than 0.1° to decrease the size of the overall package. In one example, the angle can be approximately 6°. However, the angle can be changed by adjusting the motor speed and/or by adjusting the arc power.

After the termination is completed, the center-stripped portion of the fiber can be protected, for example by using a fiber protection sleeve.

FIG. 5 is a block diagram of an apparatus that was used to demonstrate the invention. The apparatus includes a Fujikura FSM-40F fusion splicer 54, a JDS Fitel RM3750B back reflection meter 56, and a computer 58 connected to the fusion splicer by an RS-232 cable.

To demonstrate the method of the invention, first the fusion splicer was calibrated. Then the end of a Corning SMF-28® optical fiber was cleaved. A small portion, having a length of about 10 mm, of the optical fiber was stripped and placed in the fusion splicer. A back reflection reference reading was taken at 1310 nm and 1550 nm wavelengths before activating the fusion splicer. The fusion splicer arc was turned on for 75 msec at the same power that is normally used to fuse two separate pieces of fiber together (at a power of 20 bits on the splicer) to soften the fiber. This time is significantly less than the normal arc time used to fuse two separate SMF-28 fibers together. Thus, the temperature of the fiber is less than that normally used to fuse two fibers together. While the arc was on, the fiber was pushed together using the splicer motor for 500 msec at 50% speed (approximately 350 μm/sec). Next the splicer motor was turned off and the arc was allowed to remain on for an additional 50 msec at the 20 bits power level. Then the arc was turned off, and a back reflection measurement at 1310 nm and 1550 nm was taken.

Prior to bending, several samples of the optical fiber exhibited a return loss of about 14.4 dB. After bending, the return loss for each of the samples was greater than the 64 dB limit of the measuring device. The fiber used for the samples had a diameter of 125 μm and the bends in the S-shaped section had a bend radius of less than 125 μm. For samples that included the tapered portion, the return loss was also greater than the 64 dB limit of the measuring device. The S-bend had a tensile strength of at least 20 kpsi.

The method of this invention does not require additional components or adhesives. It produces a finished product with a much smaller size than produced by previous techniques. As new photonic devices shrink in size, this method will have an increasing size advantage. Terminations made in accordance with the invention can be embedded in photonic devices, or deployed in any situation including passive optical networks (PON), which require low back reflection properties to ensure proper system performance.

While this invention has been described in terms of its preferred embodiments, it will be apparent to those skilled in the art that various changes can be made to the described embodiments without departing from the scope of the invention as defined by the following claims. For example, while an arc was disclosed as a means for heating the section of the optical fiber, other known heating source could be used.

What is claimed is:

1. A method of making a fiber optic cable termination, the method comprising the steps of:
clamping an optical fiber between two spaced-apart clamps;
heating the optical fiber;
moving at least one of the clamps toward the other clamp to bend a first portion of the optical fiber into an S-shaped bend, wherein the S-shaped bend includes two or more bends, each having a radius of curvature of less than the diameter of the optical fiber.

2. A method according to claim 1, wherein the step of heating the optical fiber comprises the step of:
applying heat to the optical fiber before, during and after the step of moving at least one of the clamps toward the other clamp to bend the optical fiber.

3. A method according to claim 2, wherein the heat is provided by an arc.

4. A method according to claim 3, wherein the width of the arc is on the order of ten times the diameter of the optical fiber.

5. A method according to claim 2, further comprising the step of:
applying heat to a second portion of the optical fiber and separating the clamps to form a tapered end on the optical fiber.

6. A method according to claim 5, wherein the heat is provided by an arc.

7. A method according to claim 5, wherein the tapered end is tapered at an angle of greater than 0.1° with respect to a side of the optical fiber.

8. A method according to claim 1, wherein the optical fiber comprises one of: a single mode fiber or a multimode fiber.

9. A method according to claim 1, wherein the clamps are axially aligned.

10. A fiber optic cable termination comprising:
an S-shaped bend, wherein the S-shaped bend includes two or more bends, each having a radius of curvature of less than the diameter of the optical fiber.

11. A method of making a fiber optic cable termination, the method comprising the steps of:
clamping an optical fiber between two spaced-apart clamps;
heating the optical fiber;
moving at least one of the clamps away from the other clamp to form a tapered portion in the optical fiber, the tapered portion being tapered at an angle of greater than 0.1° with respect to a side of the optical fiber.

12. A method according to claim 11, wherein the step of heating the optical fiber comprises the step of:
applying heat to the optical fiber before, during and after the step of moving at least one of the clamps away from the other clamp.

13. A method according to claim 12, wherein the heat is provided by an arc.

14. A method according to claim 13, wherein the width of the arc is on the order of ten times the diameter of the optical fiber.

15. A method according to claim 11, wherein the optical fiber comprises one of: a single mode fiber or a multimode fiber.

16. A method according to claim 11, wherein the clamps are axially aligned.

17. A fiber optic cable termination comprising:
an optical fiber having a tapered portion adjacent to an end of the optical fiber, the tapered portion being tapered at an angle of greater than 0.1° with respect to a side of the optical fiber.

18. A fiber optic cable termination comprising:
an optical fiber formed into a S-shaped bend; and
a tapered portion between the S-shaped bend and an end of the optical fiber.

19. The fiber optic cable termination of claim 18, wherein:
the S-shaped bend includes two or more bends each having a radius of curvature of less than the diameter of the optical fiber.

20. The fiber optic cable of claim 18, wherein the tapered portion is tapered at an angle of greater than 0.1° with respect to a side of the optical fiber.

21. The fiber optic cable of claim 18, wherein the S-shaped bend has a tensile strength of at least 20 kpsi.
